(19) United States
(12) Patent Application Publication
(10) Pub. No.: US 2014/0081864 A1
(43) Pub. Date: Mar. 20, 2014

(54) Data Shares in Data Storage Clouds

(71) Applicant: Randall Reese, Beaumont, TX (US)

(72) Inventor: Randall Reese, Beaumont, TX (US)

(73) Assignee: Randall Reese, Beaumont, TX (US)

(21) Appl. No.: 14/028,252

(22) Filed: Sep. 16, 2013

Related U.S. Application Data
(60) Provisional application No. 61/701,656, filed on Sep. 15, 2012.

(51) Int. Cl. G06Q 40/02

(52) U.S. Cl. CPC G06Q 40/02
USPC 705/44

(57) ABSTRACT

Computer-implemented methods, systems, and computer programs of maintaining perpetual data shares in cloud storage are provided. An example of an embodiment of a method includes receiving a perpetual storage request including user information, a fund transfer authorization, and cloud storage parameters from a user device, sending a fund transfer request to transfer funds from a user account to a trust bank account based on the fund transfer authorization to a bank server, responsive to receiving confirmation that the trust bank account has received the transfer amount, obtaining a certificate of ownership associated with the trust bank account from a trust server, sending a cloud storage request including an identifier associated with the trust bank account and the cloud storage parameters for the perpetual data share of the cloud storage to a cloud server, and sending the login credentials for the perpetual data share to the user device.

### RELATED APPLICATION

This application claims priority to and the benefit of U.S. Provisional Application No. 61/701,656, filed on Sep. 15, 2012, incorporated herein by reference in its entirety.

### BACKGROUND OF THE INVENTION

1. Field of Invention

The present invention relates generally to perpetual cloud storage, and, more particularly, to machines, computer readable medium, program products, and methods of establishing a perpetual fund for managing content stored in cloud storage on behalf of the content owner.

2. Description of the Related Art

With the proliferation of inexpensive digital cameras, including the ubiquity of camera phones, personal photography has never been more common. It is known, however, that many photographs are underutilized. Typically, personal photographs are haphazardly stored in drawers and boxes (if prints) or computer folders and memory devices (if digital files), uncategorized and rarely viewed by anyone. Photo albums are well known for storing and viewing photographs. A photo album is a book with blank pages used for making a collection of photographs. However, the tasks associated with organizing, storing, and selecting photographs for photo albums are quite time-consuming and require extensive decision-making. While photo albums generally display photographs with or without captions, scrapbooks feature other mementos in addition to photographs, such as, e.g., ticket stubs, letters, announcements, invitations, bulletins, programs, receipts, and the like. Due to the inclusion of these mementos, scrapbooks often provide better context for photographs than photo albums, but at a cost of even more extensive decision-making.

Similarly, it is known that the proliferation of movie clips, audio clips, and other electronic files has resulted in unorganized, underutilized clutter on computer and file storage systems. Likewise, it is well known that personal documents are often haphazardly stored and uncategorized, including, e.g., personal financial records such as brokerage receipts and tax records, personal medical records such as immunization charts, and government documents such as marriage licenses.

Once storage of all of the content in the Cloud is achieved, the content is typically shared with friends, family, or other acquaintances. This sharing may be achieved through electronic mail, social networking services, or various other methods of sharing content between users. However, if the content owner dies, his content in the Cloud may longer be accessible to his friends and family. Specifically, if the fees associated with the content owner's share of the cloud are no longer paid, the content owner's share of the Cloud may be deactivated. Further, the licensing terms of the Cloud service may only allow for the content owner to access his data share.

### SUMMARY OF INVENTION

Various embodiments of systems, methods, and computer programs for maintaining perpetual data shares of cloud storage are described herein. In some aspects, provided a method for receiving a perpetual storage request including user information, a fund transfer authorization, and cloud storage parameters from a user device, sending a fund transfer request to transfer funds from a user account (bank or credit card, etc.) to a trust bank account based on the fund transfer authorization to a bank server, responsive to receiving confirmation that the trust bank account has received the transfer amount, obtaining a certificate of ownership associated with the trust bank account from a trust server, sending a cloud storage request including an identifier associated with the trust bank account and the cloud storage parameters for the perpetual data share of the cloud storage to a cloud server, and sending the login credentials for the perpetual data share to the user device.

In some aspects, provided is a system including one or more memories and one or more processors each operatively connected to the one or more memories, where the one or more memories store a perpetuity interface configured to receive a perpetual storage request including user information, a fund transfer authorization, and cloud storage parameters from a user device, send a fund transfer request to transfer funds from a user account to a trust bank account based on the fund transfer authorization to a bank server, responsive to receiving confirmation that the trust bank account has received the transfer amount, obtain a certificate of ownership associated with the trust bank account from a trust server, send a cloud storage request including an identifier associated with the trust bank account and the cloud storage parameters for the perpetual data share of the cloud storage to a cloud server, and send the login credentials for the perpetual data share to the user device.

In some aspects, provided is a system including a perpetuity server configured to receive a perpetual storage request including user information, a fund transfer authorization, and cloud storage parameters from a user device, send a fund transfer request to transfer funds from a user account to a trust bank account based on the fund transfer authorization to a bank server, responsive to receiving confirmation that the trust bank account has received the transfer amount, obtain a certificate of ownership associated with the trust bank account from a trust server, send a cloud storage request including an identifier associated with the trust bank account and the cloud storage parameters for the perpetual data share of the cloud storage to a cloud server, and send the login credentials for the perpetual data share to the user device. The system further includes the bank server configured to receive the fund transfer request from the perpetuity server, open the trust bank account, and transfer the transfer amount from the user account to the trust bank account. The system further includes the trust server configured to generate a certificate of ownership for the trust bank account and the cloud server configured to receive the cloud storage request from the perpetuity server, generate the perpetual data share by allocating space from the cloud storage to the perpetual data share, and send the login credentials for the perpetual data share to the perpetuity server.

In some aspects, provided is a non-transitory computer readable medium having computer-executable program instructions embodied therein that when executed cause a computer processor to receive a perpetual storage request including user information, a fund transfer authorization, and cloud storage parameters from a user device, send a fund transfer request to transfer funds from a user account to a trust bank account based on the fund transfer authorization to a bank server, responsive to receiving confirmation that the trust bank account has received the transfer amount, obtain a certificate of ownership associated with the trust bank account from a trust server, send a cloud storage request including an identifier associated with the trust bank account and the cloud storage parameters for the perpetual data share of the cloud storage to a cloud server, and send the login credentials for the perpetual data share to the user device.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic diagram of a client-server architecture of a perpetual data share system according to an embodiment of the present invention.

FIG. 2 is a workflow diagram for managing a perpetual data share according to an embodiment of the present invention.

FIG. 3A-3C is a workflow diagram within an example system for managing a perpetual data share according to an embodiment of the present invention.

FIG. 4A is the first part of a table of projected trust fund statistics for initial 30 years according to an embodiment of the present invention.

FIG. 4B is the second part of the table of projected trust fund statistics for initial 30 years according to an embodiment of the present invention.

FIG. 5 is a schematic diagram of user-cloud storage entity-tax-exempt entity-trust entity architecture for a perpetual data share system according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art.

Embodiments of the invention provide for managing a perpetual data share of cloud storage on behalf of a content owner. The perpetual data share is managed using a trust fund that may be initially funded, for example, by a one-time payment of the content owner. The amount of the one-time payment is determined such that the trust fund can generate sufficient interest to support the perpetual data share in perpetuity. In this example, the interest earned by the trust fund account is used to pay trust management fees, cloud storage fees, taxes, etc. and should also cover the inflation of those fees over time. Accordingly, a content owner's data share can be managed in perpetuity using funds from the trust fund.

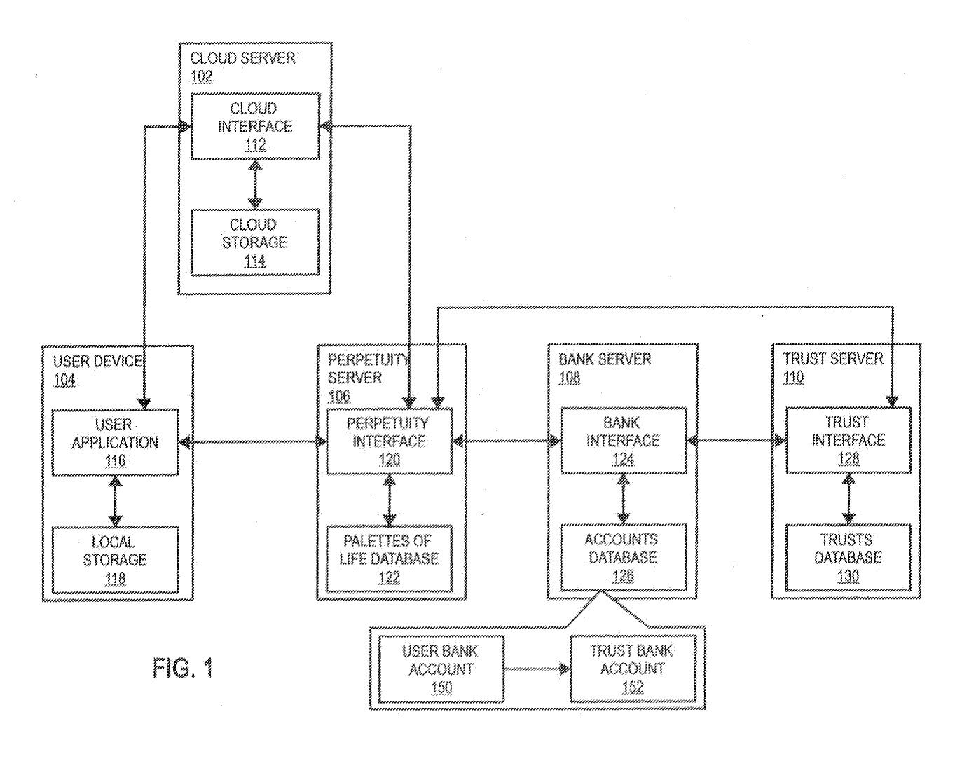

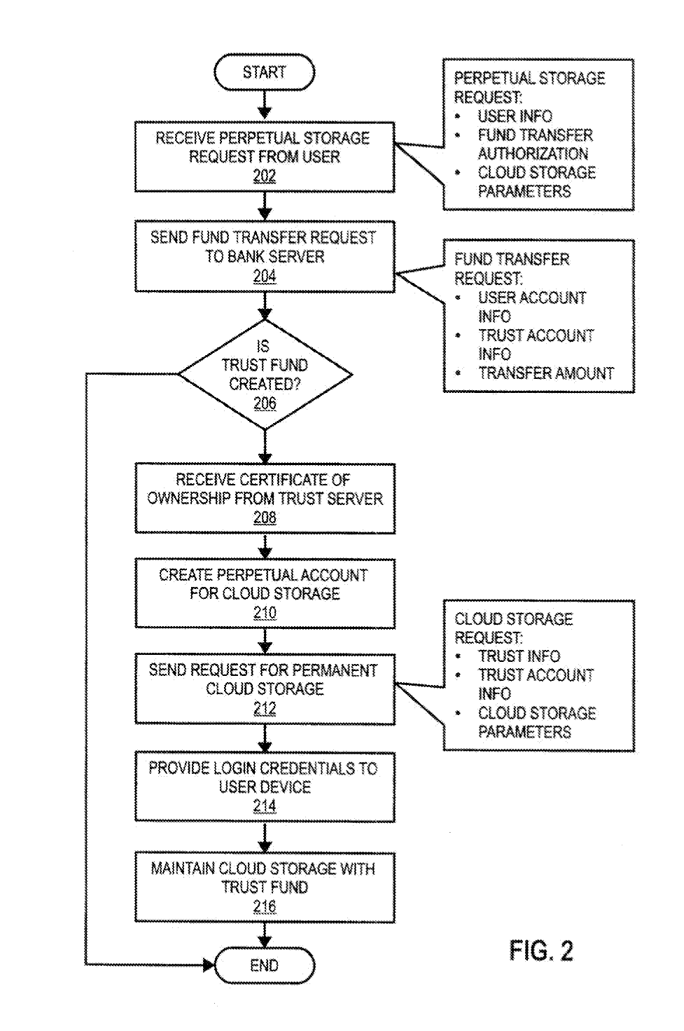

Embodiments of the present invention provide, for example, for a perpetual data share system, illustrated in FIGS. 1-2, responsive to the problems associated with limited duration data shares that must be actively managed by the content owner. The system includes a cloud server 102 interacting with a user device 104 and a perpetuity server 106. Further, the perpetuity server 106 interacts with a bank server 108, which also interacts with a trust server 110.

In some embodiments, the cloud server 102 is a computing device configured to provide cloud storage to a number of client devices such as the user device 104. In some embodiments, the cloud server 102 includes a processor, an input/output module, and a memory. The cloud server 102 may be implemented as a computing device with an operating system, stored in the memory, for providing services to requesting devices and/or servers. In some embodiments, the memory also includes a cloud interface 112 for managing access to the cloud storage 114. The aforementioned components of the cloud server 102 may be implemented on multiple computing devices (i.e., servers), where a load balancing scheme distributes requests across the multiple computing devices.

Note, the term “server” represents a server or server cluster or server farm and is not limited to any individual physical server. The server site may be deployed as a server farm or server cluster managed by a serving hosting provider. The number of servers and their architecture and configuration may be increased based on usage, demand and capacity requirements. Similarly, computer refers to one or more computers and processor refers to one or more processors housed in the same unit or in separate units.

In some embodiments, the cloud interface 112 of the cloud server 102 is configured to provide access to the cloud storage 114. Cloud storage 114 may include pools of storage that are allocated for use by user devices such as user device 104. The cloud interface 112 allows the user devices to access their corresponding data shares of the cloud storage 114 via the Internet. Specifically, the cloud interface 112 may be configured to (1) store content from the user devices in the cloud storage 114 and (2) retrieve requested content for the user devices from the cloud storage. The cloud storage 114 may correspond to an array of storage devices that are directly connected to the cloud server 102 or shared on a network.

In some embodiments, the cloud interface 112 is configured to prepare data shares of cloud storage 114 for use in response to requests for cloud storage. The cloud interface 112 may provide login credentials to the perpetuity server 106 after the data shares of cloud storage 114 are prepared. The perpetuity server 106 may be configured to then provide the login credentials to the user device 104, allowing the user device to access to the data share of the cloud storage 114 with the login credentials.

In some embodiments, the user device 104 is a mobile computing device. For example, the user device 104 may be a laptop computer, a smartphone, or a tablet computer. In some embodiments, the user device 104 includes a processor, an input/output module, and a memory. The user device 104 may be implemented as a computing device with an operating system, stored in the memory, for interacting with a user. For example, the operating system may be configured to provide applications (e.g., file management application, cloud storage application, etc.) to the user. In some embodiments, the memory includes a user application 116 and local storage 118.

In some embodiments, the user application 116 of the user device 104 is configured to assist the user in performing specific tasks. The user application 116 may be a web browser configured to consume web services via the Internet using interfaces such as the cloud interface 112 and the perpetuity interface 120. The user application 116 may be configured to present a user interface for capturing input from the user. For example, the user application 116 may collect user information, a fund transfer authorization, and cloud storage parameters from the user for submitting to the perpetuity server 120. In another example, the user application 116 may present an interface for accessing data shares in the cloud storage 114 of the cloud server 102. In this example, the user may upload content for storage in the cloud storage 114 using the user application 116, where the user application 116 interacts with the cloud interface 112 to store the content in the cloud storage 114.

In some embodiments, the local storage 118 of the user device 104 is general purpose storage apparatus (e.g., hard drive, random access memory, optical disk, etc.) of the user device 104. The local storage 118 may be used by the user device 104 to store the user's content, which may be moved or copied to the cloud storage 114 of the cloud server 102 as discussed above.

In some embodiments, the perpetuity server 106 is a computing device configured to manage perpetual data shares for a number of client devices such as the user device 104. In some embodiments, the perpetuity server 106 includes a processor, an input/output module, and a memory. The perpetuity server 106 may be implemented as a computing device with an operating system, stored in the memory, for providing services to requesting devices and/or servers. In some embodiments, the memory also includes a perpetuity interface 120 for managing data shares. The aforementioned components of the perpetuity server 106 may be implemented on multiple computing devices (i.e., servers), where a load balancing scheme distributes requests across the multiple computing devices.

In some embodiments, the perpetuity interface 120 of the perpetuity server 106 is configured to manage perpetual data shares for content owners. The perpetuity interface 120 may be configured to receive and process perpetual storage requests from the user device 104. The perpetual storage requests include user information, a fund transfer authorization, and cloud storage parameters. The user information (e.g., name, address, phone, etc.) may be used by the perpetuity interface 120 to create a user profile for the user of the user device 104. The fund transfer authorization to transfer an amount from a user account 150 (bank or credit card, etc.) to a trust bank account 152 may be forwarded by the perpetuity interface 120 to a bank server 108 for processing as discussed below. The cloud storage parameters (e.g., cloud storage provider, capacity of storage, content backup options, etc.) may be forwarded by the perpetuity server 106 to the cloud server 102 to create a data share of the cloud storage 114 for a user as discussed above.

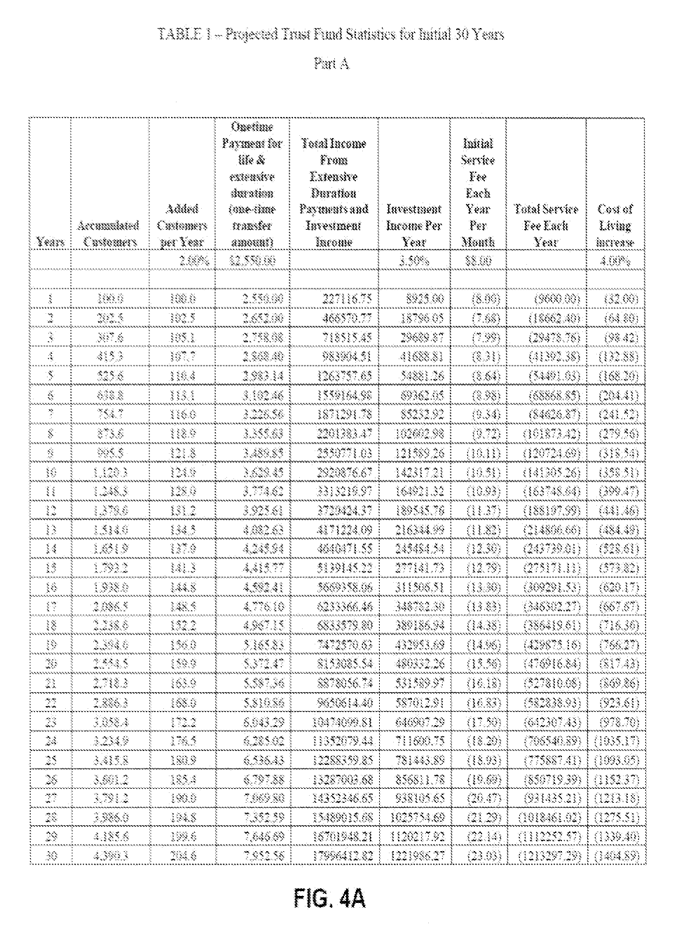

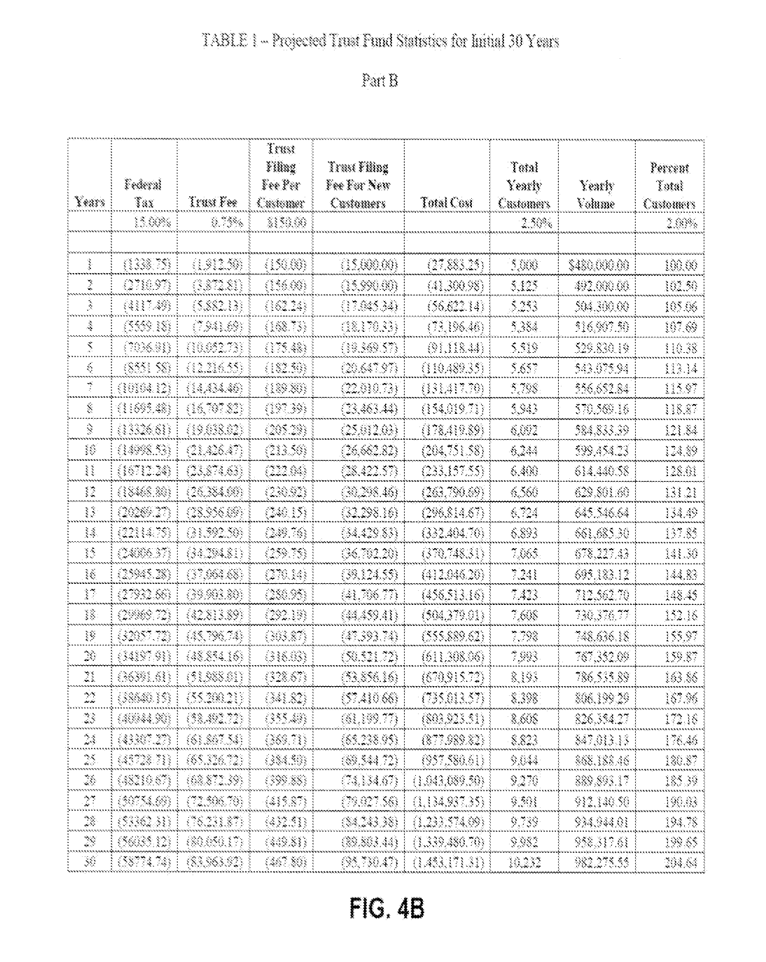

In some embodiments, the perpetuity interface 120 is configured to calculate a one-time transfer amount that generates sufficient income to maintain a perpetual data share in perpetuity. The one-time transfer amount may be calculated to account for factors such as projected investment income, inflation, taxes, and fee schedules. For example, the one-time transfer amount may be calculated as $2,500, where the projected annual investment income is 3.5%, a yearly trust fund fee of 0.75%, a trust filing fee of $150,00, a monthly cloud storage fee is $8.00, and federal taxes are 15%. In this example, a 5% cost of living increase may be applied to the trust filing fee, the monthly cloud storage fee, and to the one-time transfer amount in order to account for inflation of costs as future users are added. Further, the rate of users added by the perpetuity interface 120 may be limited to, for example, 2% per year as shown in FIGS. 4A-4B (TABLE 1) providing projected trust fund statistics for initial 30 years.

TABLE 1 shows the total income of all trust funds as 2% of the user base is added per year. Initially, the fund supports 5,000 perpetual data shares for 5,000 users. The first row shows the initial fund statistics for adding 100 new users. As users are added each year, the one-time transfer amount increases by 4%. The balance of the cumulative trust fund for all users may be calculated in any given year using the following equation (1):

TBₓ=TBₓ₋₁+TNU×AUR^{x}×OTP×INF^{x}+TBₓ₋₁×IR−TU×AC (1)

Where TB is the trust balance, x is the year, TNU is target new users per year, AUR is the added users rate, OTP is the one-time payment amount, INF is inflation, IR is the interest rate, TU is the total yearly users (i.e. customers), and AC is the annual total cost. In the example above in TABLE 1, TNU is 100, AUR is 2% added customers per year, OTP is $2,500, INF is 4%, IR is 3.5%. Further, the AC may be calculated as the annual sum of service fee, cost of living increase, federal tax, trust fee, and trust filing fee for all new customers. For each year so long as TBx is positive, the cumulative trust fund is solvent and can continue to maintain the perpetual data share of all customers. In TABLE 1, TBx for all new users starting in year 1 is represented as “Total Income From Extensive Duration Payments and Investment Income,” which is shown to increase each year as new users are added.

In some embodiments, the palettes of life database 122 is configured to store user profiles, information for corresponding perpetual data shares, and trust fund information (e.g., account number, amount of funds, projected income, etc.). The palettes of life database 122 may be used by the perpetuity interface 120 to maintain the perpetual data shares on behalf of the users of the user devices 104. For example, the palettes of life database 122 may be used by the perpetuity interface 120 to ensure that cloud storage fees are paid so that the perpetual data shares remain active. In this example, if the projected income of the trust fund is not sufficient to cover the costs of the perpetual data share, the perpetuity interface 120 may be configured to send a notification of the insufficient income to a fund manager or the user. A fund manager may be an authorized party that is responsible for managing the trust fund on behalf of the user.

In some embodiments, the bank server 108 is a computing device configured to manage perpetual data shares for a number of client devices such as the user device 104. In some embodiments, the bank server 108 includes a processor, an input/output module, and a memory. The bank server 108 may be implemented as a computing device with an operating system, stored in the memory, for providing services to requesting devices and/or servers.

In some embodiments, the memory also includes a bank interface 124 for processing financial transactions. The aforementioned components of the bank server 108 may be implemented on multiple computing devices (i.e., servers), where a load balancing scheme distributes requests across the multiple computing devices.

In some embodiments, the bank interface 124 of the bank server 108 is configured to process fund transfer requests received from the perpetuity server 106. The fund transfer requests may include information for transferring a transfer amount from a user account 150 to a trust bank account 152. In this case, the bank interface 124 may be configured to send confirmation of the fund transfer to the perpetuity server 106 and/or a trust server 110 in response to a fund transfer request. In some embodiments, the accounts database 126 is an encrypted store for storing account information (e.g., information associated with the user bank account 150 and trust bank account 152) of a financial institution associated with the bank server 108.

In some embodiments, the trust server 110 is a computing device configured to manage perpetual data shares for a number of client devices such as the user device 104. In some embodiments, the trust server 110 includes a processor, an input/output module, and a memory. The trust server 110 may be implemented as a computing device with an operating system, stored in the memory, for providing services to requesting devices and/or servers. In some embodiments, the memory also includes a trust interface 128 for facilitating the creation of trusts. The aforementioned components of the trust server 110 may be implemented on multiple computing devices (i.e., servers), where a load balancing scheme distributes requests across the multiple computing devices.

In some embodiments, the trust interface 128 of the trust server 110 is configured to create trusts that are for maintaining perpetual data shares. For example, the trust interface 128 may interact with the bank interface 124 to open a trust bank account 152 for receiving the trust funds. In this example, the trust interface 128 may be configured to generate a certificate of ownership that specifies that a fund manager associated with the perpetuity server 106 is authorized to use the trust bank account 152 to maintain a perpetual data share. The trust interface 128 may be configured to transmit the certificate of ownership to the perpetuity server 106 or the bank server 108. In some embodiments, the trust database 130 of the trust server 110 is configured to store trust information such as trust account numbers, trustee identifiers, beneficiaries, trust account balances, etc.

In some embodiments, the trust interface 128 is configured to generate a separate trust fund for each perpetual data share maintained by the perpetuity server 106. In other embodiments, the trust interface 128 is configured to generate a single trust fund that may be used to maintain all perpetual data shares maintained by the perpetuity server 106. The trust interface 128 places the funds of the trust with the fund manager in perpetuity, where the funds allow for the perpetual care of personal files in a perpetual data share of the cloud storage 114.

FIG. 2 shows a workflow diagram in accordance with one embodiment of the invention. More specifically, FIG. 2 shows a workflow of a method for creating and maintaining a perpetual data share in cloud storage. In one or more embodiments of the invention, one or more of the steps described below may be omitted, repeated, and/or performed in a different order. Accordingly, the specific arrangement of steps shown in FIG. 2 should not be construed as limiting the scope of the invention.

In 202, a perpetual storage request is received from a user (i.e., content owner). The perpetual storage request is generated based on input from the user received by, for example, a web application. The application may generate the perpetual storage request using a wizard user interface, which allows the user to specify various parameters for the perpetual storage request as discussed below. The perpetual storage request may include user information, a fund transfer authorization, and cloud storage parameters. User information may include information such as the user's name, address, phone number, etc. The fund transfer authorization may be an authorization to transfer a one-time payment into a trust fund, where the amount of the one-time payment may be determined as discussed above with respect to FIG. 1. For example, the one-time payment may authorize for $2,500 to be transferred from a bank account of a user to the trust fund. In this example, the trust fund is created for funding the management of a perpetual data share. The cloud storage parameters specify the operating parameters of the cloud storage that will be used to store the user's content. The operating parameters may include, but are not limited to, a cloud storage provider, a capacity of cloud storage (i.e., quantity of storage requested by the user), automated backup requirements, and/or a maximum monthly fee. In some embodiments, the amount of the one-time payment for the trust fund may be determined responsive to, in part, by the cloud storage parameters. For example, the one-time fee may be proportional to the capacity of the cloud storage (i.e., a greater one-time fee is determined responsive to a request for greater capacity).

In 204, the fund transfer request is sent to a bank server for processing. The bank server may be a financial server that is associated with a financial institution and that facilitates financial transactions in bank accounts held by the financial institution. The fund transfer request may include user account information, trust account information, and a transfer amount. In response to the fund transfer request, the bank server transfers the transfer amount from the user account into a newly created trust fund, which will be used to manage the perpetual data share of the content owner. In some embodiments, the trust fund may specify that the content owner is the beneficiary of the trust and that a fund manager (e.g., an authorized party associated with a perpetuity server as discussed above with respect to FIG. 1) is authorized to use the trust fund in order to maintain the perpetual share of cloud storage.

In 206, a determination is made as to whether the trust fund has been created. If the trust fund has not been created, the workflow may end. In this case if it is determined that there was an issue with the fund transfer authorization (e.g., inadequate funds, incorrect account numbers, etc.), a notification requesting additional information to resolve the issue may be sent to the user.

If the trust fund has been created, a certificate of ownership may be obtained from the trust server in 208. In some embodiments, the certificate of ownership may be a legally binding document that specifies the terms of the trust, which include a designation that the fund manager is authorized to use the trust fund to manage the perpetual data share (i.e., designates the fund manager as trustee).

In 210, a perpetual account associated with the perpetual data share of cloud storage is created for the user. The perpetual account may be used to track the management of the user's perpetual data share. For example, the perpetual account may specify operating parameters of the perpetual data share such as, but not limited to, user information, a fund manager assigned to manage the perpetual data share, the date the trust fund was created, the amount of funds in the trust fund, etc. Numerous perpetual account for a multiple users may be stored and maintained on a perpetuity server as discussed above with respect to FIG. 1.

In 212, a request for permanent cloud storage is sent to a cloud server. The request may include trust information (e.g., identification information for the trustee and/or content owner), payment information (e.g., trust account information), and cloud storage parameters. The cloud storage parameters may be the same as the cloud storage parameters specified in the perpetual storage request by the user in 202 above. In response to the request for permanent cloud storage, the cloud storage may create a perpetual data share in the cloud according to the cloud storage parameters. The cloud server may use the payment information to periodically (e.g., monthly, annually, etc.) deduct a service fee for providing the perpetual data share.

In 214, the login credentials to access the perpetual data share are provided to the user. At this stage, the user may use the login credentials to access the perpetual data share and to upload the user's content (e.g., documents, media, etc.) to the perpetual data share. The user may access the account in perpetuity while the trust fund is used by the fund manager to ensure that the perpetual data share remains active. In some embodiments, the user may specify that access rights to the perpetual data share should transfer to an inheritor upon the death of the user, where the inheritor becomes the new beneficiary of the trust. In this case, the login credentials may be transmitted to the inheritor to provide him with access.

In 216, the perpetual data share of the cloud storage is maintained using the trust fund. Specifically, the costs associated with maintaining the perpetual data share are paid using the income of the trust fund. So long as the principal of the trust fund is not affected, the perpetual data share can be maintained in perpetuity, ensuring that the stored content is perpetual as the rights to access the data share is passed onto successors.

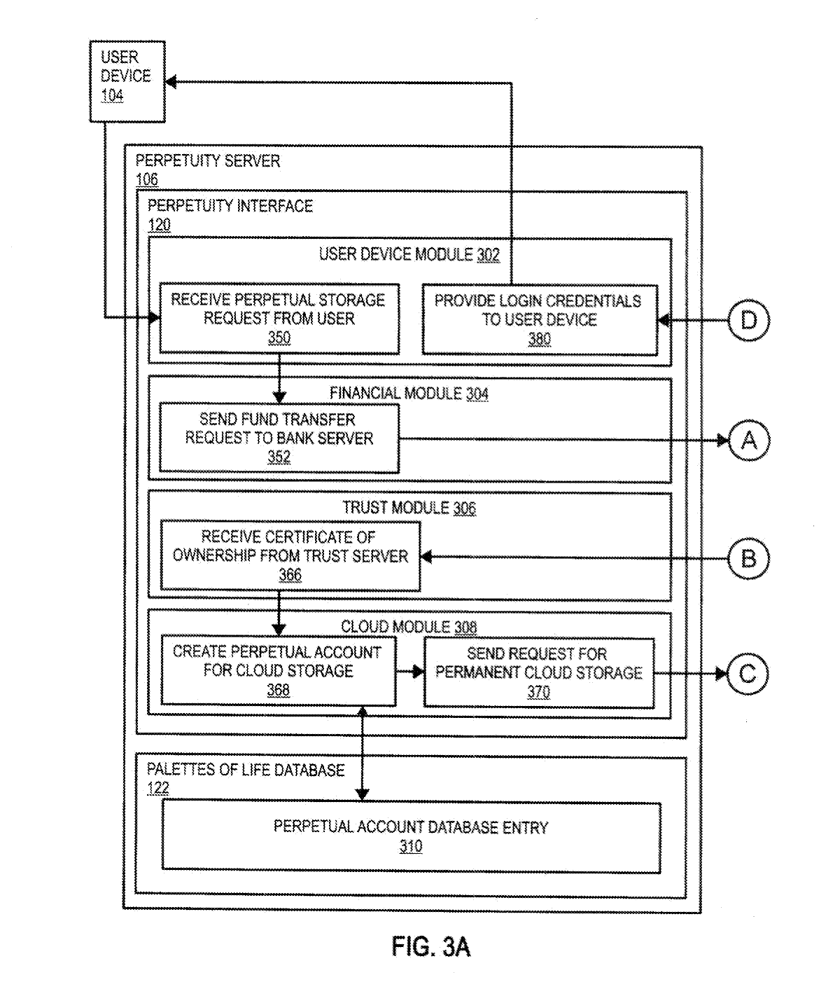

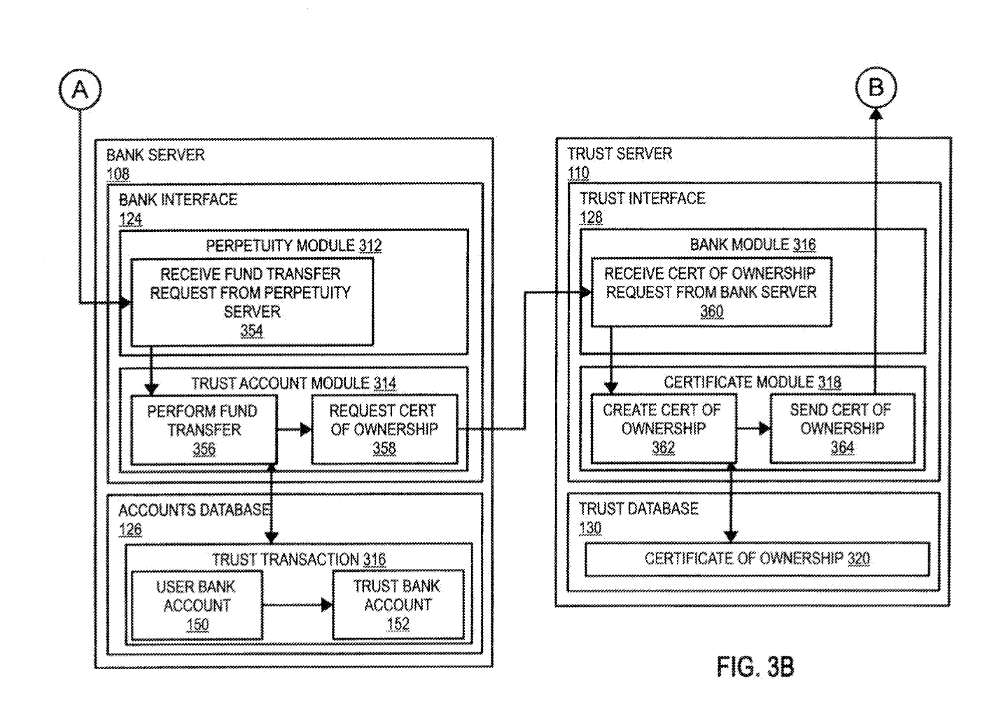

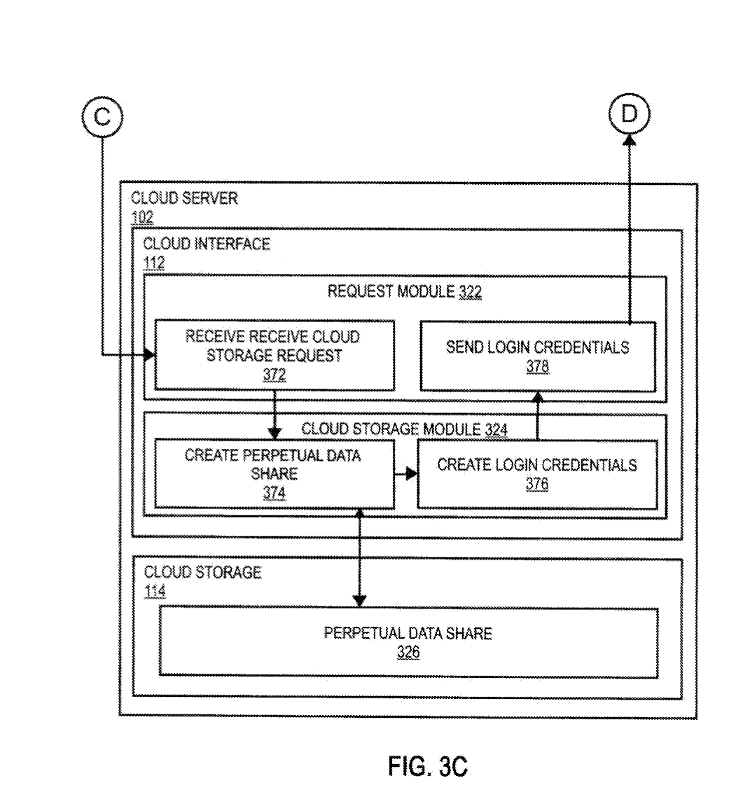

FIGS. 3A-3C shows a schematic, workflow diagram in accordance with one embodiment of the invention. More specifically, FIGS. 3A-3C shows a workflow of a method within a system for creating and maintaining a perpetual data share in cloud storage. In one or more embodiments of the invention, one or more of the steps described below may be omitted, repeated, and/or performed in a different order. Accordingly, the specific arrangement of steps shown in FIGS. 3A-3C should not be construed as limiting the scope of the invention.

In 350, a perpetual storage request is received from the user device 104 by the user to the perpetuity server 106. Specifically, the device module 302 of the perpetuity interface 120 of the perpetuity server 106 may receive and process the perpetual storage request. Based on a fund transfer authorization in the perpetual storage request, a fund transfer request is generated by the financial module 304 of the perpetuity interface 120. The fund transfer request may then be sent to the bank server 108 in 352. In 352, the fund transfer request is received by the perpetuity module 312 of the bank interface 124 of the bank server 108.

In 356, the trust account module 314 of the bank interface 124 performs the fund transfer based on the fund transfer request. Specifically, the trust account module 314 performs the trust transaction 316 by transferring the amount specified in the fund transfer request from the user account 150 to the trust bank account 152. In 358, the trust account module 314 sends a request for a certificate of ownership to the trust server 110.

In 360, the request for the certificate of ownership is received by the bank module 316 of the trust interface 128 of the trust server 110. In 362, the certificate module 318 of the trust interface 128 creates a certificate of ownership 320 based on the request received from the bank server 108. The created certificate of ownership 320 specifies that a fund manager is authorized to use the trust bank account 152 to maintain a perpetual data share 326 in cloud storage 114. In 364, the certificate of ownership 320 is sent to the perpetuity server 106.

In 366, the trust module 306 of the perpetuity interface 120 receives the certificate of ownership 320. Responsive to receiving the certificate of ownership 320, the cloud module 308 of the perpetuity interface 120 creates a perpetual account database entry 310 in the palettes of life database 122 in 368. The perpetual account database entry 310 may later be used by the cloud module 308 to maintain the perpetual data share 326 in cloud storage 114. In 370, a request for permanent cloud storage is sent to the cloud server 102.

In 372, the request for permanent cloud storage is received by the request module 322 of the cloud interface 112 of the cloud server 102. The request for permanent cloud storage may include cloud storage parameters are discussed above with respect to FIGS. 1-2. Responsive to the request for permanent cloud storage, the cloud storage module 324 of the cloud interface 112 may create the perpetual data share 326 in the cloud storage 114. In 376, the cloud storage module 324 creates the login credentials for accessing the perpetual data share 326. In 378, the request module 322 sends the login credentials to the perpetuity server.

In 380, the user device module 302 of the perpetuity interface 120 receives the login credentials, which are then forwarded onto the user device 104. At this stage, a user of the user device 104 may use the login credentials to access the perpetual data share 326 of the cloud storage 114. Specifically, the user's content (e.g., documents, pictures, videos, etc.) may be stored in and then subsequently accessed from the perpetual data share 326 using the login credentials.

One or more embodiments include a system of managing perpetual data shares. The system includes a cloud server, a bank server, a trust server, and a perpetuity server, the perpetuity server being positioned to manager perpetual data shares of cloud storage provided by the cloud server. The system also includes a number of user devices associated with a numbers of users defining user computers, each user computer in communication with the file perpetuity server through an electronic communications network. The system further includes a computer program product associated with the perpetuity server as discussed below.

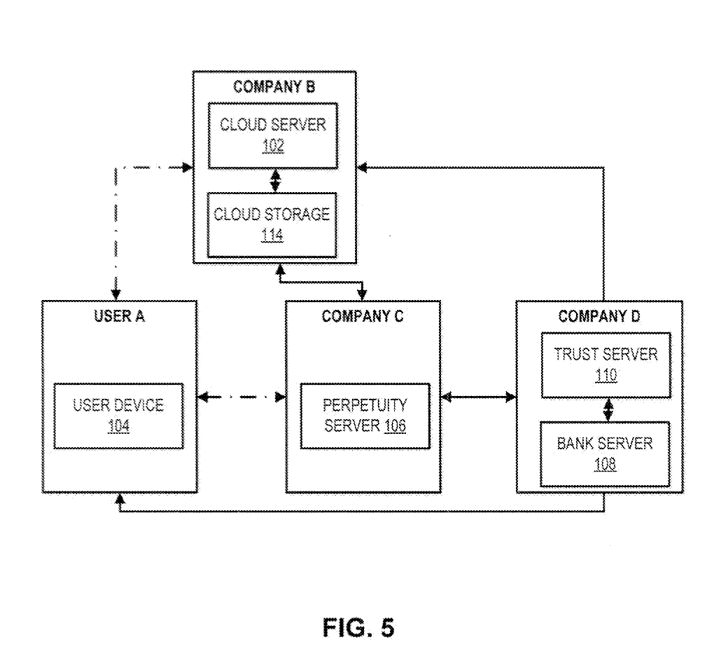

As shown in FIG. 5, according to an embodiment, as projected in general terms, User A connects to Company B's cloud server 102 using a user device 104. Once connected User A requests, is presented with, and fills out a cloud service request form and payment (funds transfer authorization) form to purchase a “tax free” cloud storage 114 associated with the cloud server 102 for an indeterminate (e.g., perpetual) length of time. User A then sends the cloud service request form and payment form to Company B's cloud server 102. The forms can be in hard copy and/or presented as webpages having fillable fields to retrieve the necessary information (not shown).

According to an exemplary configuration, Company B either has tax-exempt status (e.g., under section 501c3) or is affiliated with a Company or other entity having tax-exempt status. If the affiliation is with a separate company, e.g., Company C, a perpetuity server 106 can be managed independently by Company C. Company C can be a subsidiary of Company B, or alternatively, a separate company affiliated through contract, for example.

According to the exemplary embodiment, Company B's cloud service then sends the payment/payment reference to Company C's computer, such as, for example, perpetuity server 106. Company C's computer then sends the payment/payment reference to a Bank and/or Trust Company D's computer, such as, for example, bank server 110 and/or trust server 111 (shown, for illustrative purposes only, as falling under the same entity), at which time trust Company D's computer sends an electronic receipt to User A's user device 104. The electronic receipt can be provided directly to user A's user device 104, indirectly through the cloud server 102, or indirectly through perpetuity server 106 and/or cloud server 102.

Company D then invests the funds and pays a periodic fee (e.g., monthly, annually, etc.) to Company B to maintain the information uploaded into cloud storage 114 by User A for an undetermined amount of time. The periodic fee can be directly deposited in a bank account assigned to Company B. Alternatively, the periodic fee can be deposited in a bank account assigned to Company C, the tax-exempt entity.

Embodiments of the present invention include a computer program product, stored on a tangible computer memory media, operable on a computer, the computer program product including a set of instructions that, when executed by the computer, cause the computer to perform various operations. The operations include interacting with a cloud server to create a perpetual data share of cloud storage, interacting with a bank server to transfer user funds to a trust fund, interacting with a trust server to create a certificate of ownership authorizing a fund manager to maintain the perpetual data share with the trust fund, and maintain the perpetual data share with the trust fund.

Other architectures, implementations, and organizations will be understood by those skilled in the art to be included within the embodiments of the present invention. Program products can be implemented in a variety of software and programming languages, including without limitation hypertext markup language (“HTML”), Java, C, C++, XML, JavaScript, and others as understood by those skilled in the art. Multi-processor computers, cloud computing, server farms, multiple computer systems, multiple databases and storage devices (including hierarchies of storage and access), and other implementations will be recognized by those having skill in the art as encompassed within the embodiments of the present invention. For example, a single computer, a plurality of computers, a server, or server cluster or server farm may be employed, and this disclosure does not limit any configuration of computers and servers for each. Moreover, each may be deployed as at a server farm, data center or server cluster managed by a server host, and the number of servers and their architecture and configuration may be increased based on usage, demand, and capacity requirements for the system. Moreover, embodiments include clusters of computers, servers, storage devices, display devices, and components interacting together, as understood by those skilled in the art.

A person having ordinary skill in the art will recognize that various types of memory are readable by a computer such as described herein, e.g., user device, perpetuity server, or other computers and machine within embodiments of the present invention. Examples of non-transitory computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system, program product, and the method steps described above and can operate on a computer. It will be understood by those skilled in the art that such media can be at other locations instead of or in addition to file management computer server to store program products, e.g., including software, thereon.

This application relates to U.S. Non-Provisional patent application Ser. No. 12/620,944, filed on Nov. 18, 2009, titled “Machine, Program Product, and Computer-Implemented Method For File Management, Storage, and Display which claims priority to and the benefit of U.S. Provisional Patent Application Ser. No. 61/116,814, by Reese et al., titled “System, Program Product, and Method for File Management, Storage, and Retrieval” filed Nov. 21, 2008; U.S. Provisional Patent Application Ser. No. 61/116,831, by Reese et al., titled “System, Program Product, and Method for File Management, Storage, and Retrieval” filed Nov. 21, 2008; U.S. Provisional Patent Application Ser. No. 61/116,862, by Reese et al., titled “System, Program Product, and Method for File Management, Storage, and Retrieval” filed Nov. 21, 2008; U.S. Provisional Patent Application Ser. No. 61/116,894, by Reese et al., titled “System, Program Product, and Method for File Management, Storage, and Retrieval” filed Nov. 21, 2008; and U.S. Provisional Patent Application Ser. No. 61/116,914, by Reese et al., titled “System, Program Product, and Method for File Management, Storage, and Retrieval” filed Nov. 21, 2008, all of which are each incorporated herein by reference in their entireties. This application also relates to: U.S. patent application Ser. No. 12/620,963, by Reese et al., titled “Machine, Program Product, and Computer-Implemented Method for File Management and Storage” filed on Nov. 18, 2009; U.S. patent application Ser. No. 12/621,059, by Reese et al., titled “Machine, Program Product, and Computer-Implemented Method for Randomized Slide Show of Files” filed on Nov. 18, 2009; U.S. patent application Ser. No. 12/621,033, by Reese et al., titled “Machine, Program Product, and Computer-Implemented Method for File Management, Storage, and Display in Albums Utilizing a Questionnaire” filed on Nov. 18, 2009; and U.S. patent application Ser. No. 12/620,995, by Reese et al., titled “Machine, Program Product, and Computer-Implemented Method for File Management, Storage, and Access Utilizing a User-Selected Trigger Event” filed on Nov. 18, 2009, all of which are each incorporated herein by reference in their entireties.

Many modifications and other embodiments of the invention will come to the mind of one skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That claimed is:

1. A computer-implemented method of maintaining perpetual data shares of cloud storage, the computer-implemented method comprising:
receiving a perpetual storage request from a user via a user device, the perpetual storage request comprising user information, a fund transfer authorization, and cloud storage parameters;
sending a fund transfer request to a bank server based upon the fund transfer authorization, the fund transfer request requesting that a predetermined transfer amount be transferred from a user account to a trust bank account;
responsive to confirmation that the trust bank account has received the transfer amount, obtaining a certificate of ownership from a trust server, the certificate of ownership authorizing a fund manager to use the trust bank account to maintain a perpetual data share of the cloud storage;
sending a cloud storage request for the perpetual data share of the cloud storage to a cloud server, the cloud storage request comprising an identifier associated with the trust bank account and the cloud storage parameters; and
responsive to receiving login credentials for the perpetual data share, sending the login credentials to the user device.

2. A method as defined in claim 1,
wherein the trust bank account generates income sufficient to maintain the perpetual data share in perpetuity; and
wherein the method further comprises authorizing a monthly fee associated with the perpetual data share be paid from the trust bank account.

3. A method as defined in claim 1,
wherein the predetermined transfer amount is invested in trust to generate interest sufficient to satisfy payment for an amount of requested cloud storage in perpetuity defined by the cloud storage parameters;
wherein the interest is sufficient to satisfy payment for the amount of requested cloud storage in perpetuity accounts for periodic cost-of-living increases; and
wherein the method further comprises the step of receiving payment data periodically indicating payment amounts being sufficient to maintain the amount of requested cloud storage periodically adjusted for cost-of-living increases.

4. A method as defined in claim 1,
wherein the step of sending the fund transfer request to a bank server is performed by a tax-exempt entity.

5. A method as defined in claim 4,
wherein the cloud server is associated with an entity hosting cloud storage;
wherein the step of receiving the perpetual storage request is performed by the cloud server; and
wherein the step of sending the fund transfer request to a bank server comprises the cloud server sending a fund transfer request to a server affiliated with the tax-exempt entity followed by the tax-exempt entity sending the fund transfer request to the bank server, the bank server hosting the trust bank account.

6. A system for maintaining perpetual data shares of cloud storage, comprising a perpetuity server configured to perform the method as defined in claim 1,
the system further comprising the cloud server being configured to perform the steps of:
receiving the cloud storage request from the perpetuity server;
generating the perpetual data share by allocating space from the cloud storage to the perpetual data share; and
sending the login credentials for the perpetual data share to the perpetuity server.

7. A system as defined in claim 6, further comprising the bank server being configured perform the steps of:
receiving the fund transfer request from the perpetuity server, open the trust bank account; and
transferring the transfer amount from the user account to the trust bank account; the trust server configured to generate a certificate of ownership for the trust bank account.

8. A computer-implemented method of maintaining perpetual data shares of cloud storage, the computer-implemented method comprising the steps of:
providing a perpetual storage request and payment authorization form presented over one or more webpages to a user via a user device, the perpetual storage request and payment authorization form comprising fields for entering user information, a fund transfer authorization, and cloud storage parameters defining a perpetual storage request;
receiving the perpetual storage request through the perpetual storage request and payment authorization form; and
sending a fund transfer request to a trust entity based upon the fund transfer authorization, the fund transfer request requesting that a predetermined transfer amount be transferred from a user account to an account associated with a trust entity defining a trust entity bank account, the predetermined transfer amount being invested in trust to generate interest sufficient to satisfy payment for an amount of requested cloud storage in perpetuity defined by the cloud storage parameters, the step of sending the fund transfer request comprising a tax-exempt entity or the user sending the fund transfer request to the trust entity.

9. A method as defined in claim 8,
wherein the step of receiving a perpetual storage request is performed by an entity hosting cloud storage; and
wherein the step of sending the fund transfer request to the trust entity comprises the entity hosting cloud storage sending the fund transfer request to the tax-exempt entity followed by the tax-exempt entity sending the fund transfer request to the trust entity.

10. A method as defined in claim 8,
wherein the interest sufficient to satisfy payment for the amount of requested cloud storage in perpetuity, accounts for periodic cost-of-living increases; and
wherein the method further comprises an entity hosting cloud storage receiving periodic payments for the amount of requested cloud storage being adjusted for cost-of-living increases.

11. A method as defined in claim 8, wherein the trust entity performs the steps of:
investing the predetermined transferred amounts in trust to generate interest sufficient to satisfy payment for an amount of requested cloud storage in perpetuity defined by the cloud storage parameters; and
providing periodic payments in amounts being sufficient to maintain the amount of requested cloud storage periodically adjusted for cost-of-living increases.

12. A method as defined in claim 8, wherein the trust entity performs the step of:
providing an electronic receipt to the user via the user device responsive to the trust entity receiving confirmation that the trust bank account has received the predetermined transfer amount.

13. A method as defined in claim 8, wherein the user or the tax-exempt entity provides authorization to a trust fund manager to use the trust bank account to maintain a perpetual data share of the cloud storage by providing periodic payments sufficient to satisfy payment for the amount of requested cloud storage.

14. A method as defined in claim 8,
wherein the step of receiving the perpetual storage request through the perpetual storage request and payment authorization form is performed by the tax-exempt entity; and
wherein the step of sending the fund transfer request to the trust entity comprises a server affiliated with the tax-exempt entity sending the fund transfer request to a server affiliated with the trust entity.

15. A non-transitory computer readable medium or media embodying computer-executable program code comprising instructions that when executed by one or more processors, cause the one or more processors to perform the operations of:
receiving a perpetual storage request from a user via a user device, the perpetual storage request comprising user information, a fund transfer authorization, and cloud storage parameters;
sending a fund transfer request to a bank server based upon the fund transfer authorization, the fund transfer request requesting that a predetermined transfer amount be transferred from a user account to a trust bank account;
responsive to receiving confirmation that the trust bank account has received the transfer amount, obtaining a certificate of ownership from a trust server, the certificate of ownership authorizing a fund manager to use the trust bank account to maintain a perpetual data share of the cloud storage;
sending a cloud storage request for the perpetual data share of the cloud storage to a cloud server, the cloud storage request comprising an identifier associated with the trust bank account and the cloud storage parameters; and
responsive to receiving login credentials for the perpetual data share, sending the login credentials to the user device.

16. A non-transitory computer readable medium or media as defined in claim 15,
wherein the trust bank account generates income sufficient to maintain the perpetual data share in perpetuity; and
wherein the operations further comprising providing the trust entity authorization to pay a monthly fee associated with the perpetual data share from the trust bank account.

17. A non-transitory computer readable medium or media as defined in claim 15,
wherein the predetermined transfer amount is generates interest sufficient to satisfy payment for an amount of requested cloud storage in perpetuity defined by the cloud storage parameters;
wherein the interest sufficient to satisfy payment for the amount of requested cloud storage in perpetuity accounts for periodic cost-of-living increases; and
wherein the operations further comprise receiving payment data periodically indicating payment amounts being sufficient to maintain the amount of requested cloud storage adjusted for cost-of-living increases.

18. A non-transitory computer readable medium or media as defined in claim 15,
wherein the operation of sending the fund transfer request to a bank server is performed by a computer affiliated with a tax-exempt entity.

19. A non-transitory computer readable medium or media as defined in claim 18,
wherein the cloud server is affiliated with an entity hosting cloud storage;
wherein the operation of receiving the perpetual storage request is performed by the cloud server; and
wherein the operation of sending the fund transfer request to a bank server comprises the cloud server sending a fund transfer request to the computer affiliated with the tax-exempt entity followed by the tax-exempt entity sending the fund transfer request to the bank server, the bank server hosting the trust bank account.

20. A non-transitory computer readable medium or media embodying computer-executable program code comprising instructions that when executed by one or more processors, cause the one or more processors to perform the operations of:
providing a perpetual storage request and payment authorization form to a user via a user device, the perpetual storage request and payment authorization form comprising fields for entering user information, a fund transfer authorization, and cloud storage parameters defining a perpetual storage request presented over one or more webpages;
receiving the perpetual storage request through the perpetual storage request and payment authorization form; and
sending a fund transfer request to a server affiliated with a trust entity based upon the fund transfer authorization, the fund transfer request requesting that a predetermined transfer amount be transferred from a user account to an account associated with the trust entity to define a trust entity bank account, the predetermined transfer amount being invested in trust to generate interest sufficient to satisfy payment for an amount of requested cloud storage in perpetuity defined by the cloud storage parameters, the operation of sending the fund transfer request comprising a server affiliated with a tax-exempt entity sending the fund transfer request to the server affiliated with the trust entity.

21. A non-transitory computer readable medium or media as defined in claim 20,
wherein the operation of receiving a perpetual storage request is performed by a server affiliated with an entity hosting cloud storage; and
wherein the operation of sending the fund transfer request to the server affiliated with the trust entity comprises the server affiliated with the entity hosting cloud storage sending the fund transfer request to the server affiliated with the tax-exempt entity followed by the server affiliated with the tax-exempt entity sending the fund transfer request to the server affiliated with the trust entity.

22. A non-transitory computer readable medium or media as defined in claim 20,
wherein the interest sufficient to satisfy payment for the amount of requested cloud storage in perpetuity, accounts for periodic cost-of-living increases; and
wherein the operations further comprise a server affiliated with an entity hosting cloud storage receiving payment data periodically indicating payment amounts sufficient to maintain the amount of requested cloud storage periodically adjusted for cost-of-living increases.

23. A non-transitory computer readable medium or media as defined in claim 20, the operations further comprising:
the server affiliated with the trust entity providing an electronic receipt to the user via the user device responsive to the server affiliated with the trust entity receiving confirmation that the trust bank account has received the predetermined transfer amount.

24. A non-transitory computer readable medium or media as defined in claim 20, the operations further comprising:
the user device or the server affiliated with the tax-exempt entity providing a computer associated with the trust entity with data indicating authorization to a trust fund manager to use the trust bank account to maintain a perpetual data share of the cloud storage by providing periodic payments sufficient to satisfy payment for the amount of requested cloud storage; and
the server affiliated with the trust entity sending payment data periodically indicating payment amounts sufficient to maintain the amount of requested cloud storage periodically adjusted for cost-of-living increases.

25. A non-transitory computer readable medium or media as defined in claim 20,
wherein the step of receiving the perpetual storage request through the perpetual storage request and payment authorization form is performed by the server affiliated with the tax-exempt entity; and
wherein the operation of sending the fund transfer request to the server affiliated with the trust entity comprises the server affiliated with the tax-exempt entity sending the fund transfer request to the server affiliated with the trust entity.
